(19) United States
(12) Patent Application Publication
(10) Pub. No.: US 2019/0109888 A1
(43) Pub. Date: Apr. 11, 2019

(54) MULTI-TIERED, CLOUD BASED, FILE SYSTEM FOR DEVICES WITH UNSTABLE NETWORK CONNECTION

(71) Applicant: Huawei Technologies Co., Ltd., Shenzhen (CN)

(72) Inventor: Shoham LEVY, Munich (DE)

(21) Appl. No.: 16/212,977

(22) Filed: Dec. 7, 2018

Related U.S. Application Data
(63) Continuation of application No. PCT/EP2016/063181, filed on Jun. 9, 2016.

(51) Int. Cl. H04L 29/08

(52) U.S. Cl. CPC H04L 67/06; H04L 67/1097

(57) ABSTRACT

A system and method for managing an access to a file, including storing in a local memory of a device at least one reduced-size versions of a media file stored in a network accessible storage, receiving a request to access the media file via a file system of an operating system executed by at least one processor of the device, determining, based on an analysis of the request, whether to use the network interface for fetching a copy of the media file from the network accessible storage and responding to the request with the copy, or to respond to the request with at least one of the reduced-size versions.

### CROSS-REFERENCE TO RELATED APPLICATIONS

This application is a continuation of International Application No. PCT/EP2016/063181, filed on Jun. 9, 2016, the disclosure of which is hereby incorporated by reference in its entirety.

### BACKGROUND

The size of the local storage of current mobile devices is usually insufficient for storing of all the media files and/or applications required by the user. The cost and physical attributes of a local storage unit limit the ability to increase the storage capacity, while the number and size of media files and applications required by users increase constantly.

Some solutions include extension storage devices that may be mounted on the mobile device, such as all kinds of Secure Digital (SD) cards. However, such extension storage devices are usually much slower than the local storage unit and less secure. Additionally, the inclusion of an SD card slot in a mobile device may put constraints on the device's size and/or design.

Other solutions may include backing up data to cloud storage and deleting it from the device local memory. Such cloud storage solutions, such as, for example, Android Photos and iOS Photos, are usable mostly for backing up of data and sharing purposes.

### SUMMARY

According to a first aspect, a device of managing an access to a file is provided, comprising a network interface; a local memory adapted to store at least one reduced-size version of a media file stored in a network accessible storage; at least one processor adapted to receive a request to access the media file via a file system of an operating system executed by the at least one processor; to determine, based on an analysis of the request, whether to use the network interface for fetching a copy of the media file from the network accessible storage and responding to the request with the copy, or to respond to the request with one of the reduced-size versions; and to respond to the request according to the determination.

In a first possible implementation of the device according to the first aspect, the analysis comprises an analysis of at least one characteristic of an application or an operating system service or a device framework service submitting the request.

The request can be received via a kernel level IO operation.

In a second possible implementation form of the device according to the first aspect as such or according to the first implementation form of the first aspect, the analysis comprises an analysis of at least one action performed by an application submitting the request prior to submitting the request.

In a third possible implementation form of the device according to the first aspect as such or according to any of the implementation forms of the first aspect, the at least one processor is adapted to instruct storing a full version of said media file in conjunction with the at least one reduced-size versions.

In a fourth possible implementation form of the device according to the first aspect as such or according to any of the implementation forms of the first aspect, the at least one processor is adapted to monitor at least one access characteristic of an access to the reduced-size version and to instruct deleting the full version from the local memory according to the at least one access characteristic.

In a fifth possible implementation form of the device according to the first aspect as such or according to any of the implementation forms of the first aspect, the media file encodes a member of a group consisting of an image, a video, a set of images, and an audio file, and a graphic data file.

In a seventh possible implementation form of the device according to the first aspect as such or according to any of the implementation forms of the first aspect, the local memory is a non-volatile memory.

In an eighth possible implementation form of the device according to the first aspect as such or according to any of the implementation forms of the first aspect, a storage size of at least one of the reduced-size versions is of a fixed relation to the storage size of the original media file.

In a ninth possible implementation form of the device according to the first aspect as such or according to any of the implementation forms of the first aspect, a storage size of at least one of the reduced-size versions is of a pre-determined fixed size.

In a eleventh possible implementation form of the device according to the first aspect as such or according to any of the implementation forms of the first aspect, the at least one processor is adapted to instruct the network interface to send the media file for storage at the network accessible storage; wherein at least one of the reduced-size versions are received via the network interface for storage at the local memory.

In a twelfth possible implementation form of the device according to the first aspect as such or according to any of the implementation forms of the first aspect, the at least one processor is adapted to instruct the network interface to send the media file for storage at the network accessible storage; wherein at least one of the reduced-size versions are generated locally on the device by at least one processor adapted to reduce media size for storage at the local memory.

According to a second aspect, a method of managing an access to a file is provided, comprising storing in a local memory of a device at least one reduced-size versions of a media file stored in a network accessible storage; receiving a request to access the media file via a file system of an operating system executed by at least one processor of the device; and determining, based on an analysis of the request, whether to use the network interface for fetching a copy of the media file from the network accessible storage and responding to the request with the copy, or to respond to the request with at least one of the reduced-size versions.

According to a third aspect, a software program product for managing access to a file is provided, comprising: a non-transitory computer readable storage medium; first program instructions for storing in a local memory of a device at least one reduced-size versions of a media file stored in a network accessible storage; second program instructions for receiving a request to access the media file via a file system of an operating system executed by at least one processor of the device; and third program instructions for determining, based on an analysis of the request, whether to use the network interface for fetching a copy of the media file from the network accessible storage and responding to the request with the copy, or to respond to the request with at least one of the reduced-size versions; wherein said first, second, and third program instructions are executed by at least one computerized processor from said non-transitory computer readable storage medium.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example and for purposes of illustrative discussion of embodiments of the present disclosure. In this regard, the description taken with the drawings makes apparent to those skilled in the art how embodiments of the present disclosure may be practiced.

In the drawings:

FIG. 1 is a schematic flowchart illustrating a method for managing file access, according to some embodiments of the present disclosure;

FIG. 2 is a schematic illustration of a system for managing file access, according to some embodiments of the present disclosure;

FIG. 3 is a schematic illustration of a system for managing file access in which a processor is located in an external file managing server according to some embodiments of the present disclosure;

FIG. 4 is a schematic illustration of a system for managing file access according to some other embodiments of the present disclosure;

FIG. 5 is a schematic illustration of a system for managing file access according to further embodiments of the present disclosure;

FIG. 6 is a schematic illustration of a system for generating and storing of reduced-size files, according to some embodiments of the present disclosure; and

FIG. 7 is a schematic illustration of a system for generating and storing of reduced-size files, according to some other embodiments of the present disclosure.

### DETAILED DESCRIPTION

In Android cloud storage solutions, private files of third-party applications cannot be backed up in the cloud, because third-party applications may have no access rights to the cloud, and the installed applications are also not backed up. Additionally, a file can be removed from local storage only when the user deletes it manually. In iOS cloud storage solutions, in certain device modes, all media files on the device are automatically scaled down to a lower resolution, while keeping the original only in the cloud. Additionally, media files are deleted from the device at the discretion of the iOS photos application.

Other solutions offload the least used image and application files to a cloud storage, wherein special APIs or manual user settings are required for access by third-party applications.

The solution provided by some embodiments of the present disclosure replaces media files stored on a device with corresponding reduced-size files, and stores the full-sized files on a cloud. Thus, usable copies of the media files may always be accessible to applications running on the device. Full versions of the files may be deleted from the device, downloaded to the device or kept on the device, depending, for example, on how frequently and/or recently the files are being used. Full versions of rarely used files may be deleted from the device, while keeping on the device a reduced-size file. In case a file is used frequently, the full version may be downloaded to the device from the cloud and/or kept on the device.

The solution provided by some embodiments of the present disclosure operates at the file system level and constitutes a designated file system that decides which version of the file to provide to the requesting application. The operations and/or decision making of the designated file system are transparent to the requesting application, e.g., the requesting application receives a file in response to its request without being involved in the decision.

Before explaining at least one embodiment of the present disclosure in detail, it is to be understood that the present disclosure is not necessarily limited in its application to the details of construction and the arrangement of the components and/or methods set forth in the following description and/or illustrated in the drawings and/or the Examples. The present disclosure is capable of other embodiments or of being practiced or carried out in various ways.

The present disclosure may be a system, a method, and/or a computer program product. The computer program product may include a computer readable storage medium (or media) having computer readable program instructions thereon for causing a processor to carry out aspects of the present disclosure.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

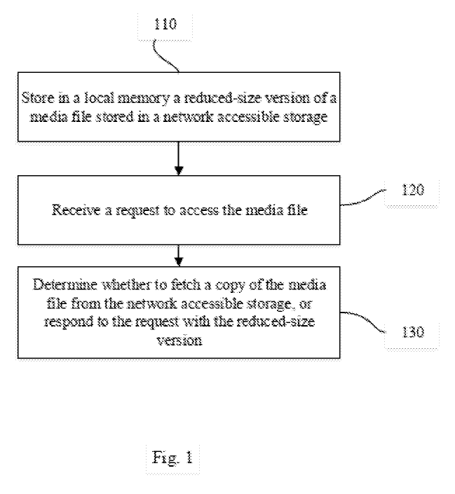

Reference is now made to FIG. 1, which is a schematic flowchart illustrating a method 100 for managing file access, according to some embodiments of the present disclosure. As indicated in block 110, one or more processor(s), referred to as a processor, instructs storing in a local memory of a device a reduced-size version of a media file stored in a network accessible storage. As indicated in block 120, the processor may receive a request to access the media file via a file system of an operating system executed by at least one processor of the device. As indicated in block 130, the processor may determine, based on an analysis of the request, whether to use the network interface for fetching a copy of the media file from the network accessible storage and responding to the request with the copy, or respond to the request with one of the locally stored reduced-size versions.

Some embodiments of the present disclosure may provide a software program product for managing file access, the software program product may include a non-transitory computer readable storage medium that may store program instructions, which, when executed by a processor, may cause the processor to carry out method 100.

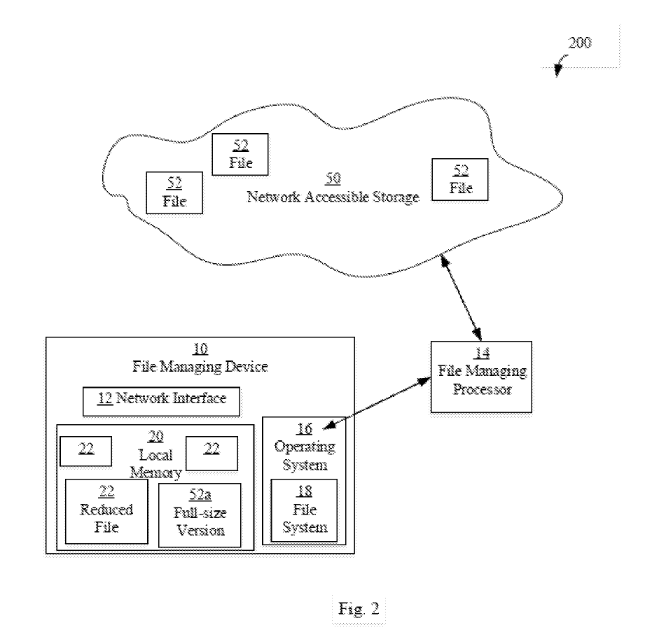

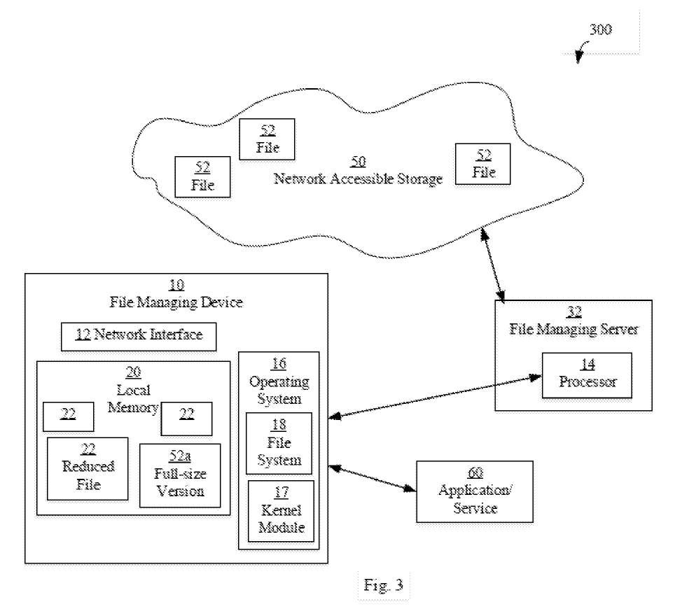

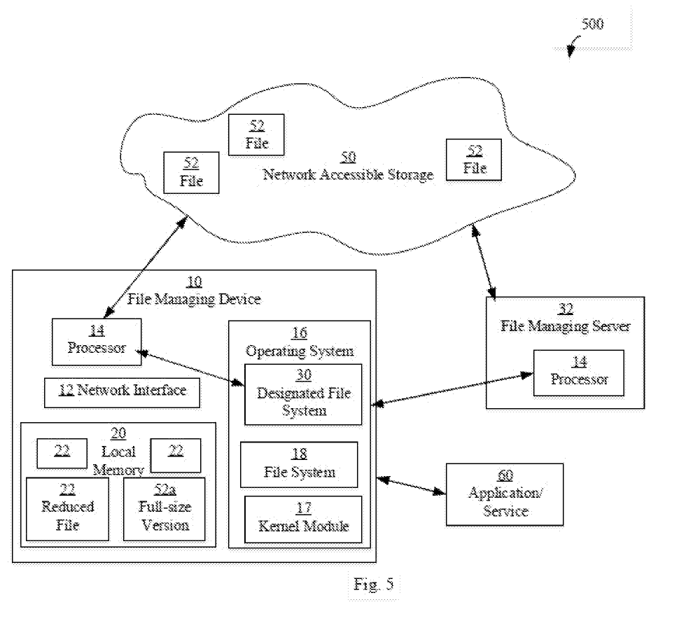

Further reference is now made to FIG. 2, which is a schematic illustration of a system 200 for managing file access, according to some embodiments of the present disclosure. System 200 may include a network accessible storage 50, a file managing device 10 and a file managing processor 14. File managing processor 14 may be included in device 10 and/or in an external file managing server (shown, for example, in FIGS. 3 and 5). Network accessible storage 50 may store a plurality of files 52 including, for example, media files that may each include, for example, an encoded image, video, set of images, audio file, graphic data file, and/or any other suitable encoded media. Device 10 may include a network interface 12, an operating system 16, a file system 18 and a local memory 20. Local memory 20 may be a nonvolatile memory and/or may store, for example, a plurality of reduced files 22, which may include reduced size versions of files 52. In some embodiments, the ratio between a storage size of each reduced-size file 22 and the storage size of the corresponding file 52 may be a fixed predetermined constant. The ratio may be determined, for example, according to the relative quality acceptable for reduced-size files 22.

In some other embodiments, the reduced-size file 22 may be of a pre-defined fixed size, unrelated to the size of the corresponding file 52, for example when an application has certain size requirements. In some cases, a full version 52a of file 52 may also be stored in local memory 20.

Reduced-size file 22 may have, for example, a reduced quality compared to the corresponding file 52. In some embodiments of the present disclosure, the size of a reduced-size file 22 may be about 10 percent of the size of the corresponding file 52. In another example, the size of a reduced-size file 22 is about 20 percent of the size of the corresponding file 52. In another example, the size of reduced-size file 22 is 100K or less. Optionally, file 22 may have lower resolution, may be lossy-compressed, may have lower bit-rate, and/or may be reduced by any other suitable method.

A file 52 may have several associated reduced-size files 22 stored in local memory 20, for example of different sizes, wherein each version may be used for other purposes and/or applications. For example, several reduced-size files 22 associated with a same file 52 may include, for example, a file 22 with a size determined according to the fixed pre-determined ratio, a file 22 with a pre-defined fixed size required for a certain application, a file 22 with another predefined fixed size required for another application, a file 22 with another, very small, size pre-defined for very old and/or unused files, and/or any other files 22 with different size.

Processor 14 may control an operating system 16 and/or file system 18. Processor 14 may receive a request to access a file 52 from a requesting software entity such as, for example, an application, an operating system service, a device framework service, or any other suitable requesting entity. The request may be received, for example, via file system 18, for example, via a kernel level input-output (IO) operation. In some embodiments of the present disclosure, processor 14 may intercept an intent and/or activity of a software entity that may require and/or call for a file 52. Processor 14 may manage the allocation and/or retrieving of files 22, 52 and/or 52a. Processor 14 may decide which version of the file, for example one of the reduced files 22 or the full version file 52 or file 52a, to provide to the requesting entity. The decision may be made, for example, by checking compliance to a rule or a series of rules that may relate, for example, to a type of the requesting entity, a time of the day, a file size, an action performed by the requesting entity and/or any other suitable parameter. Processor 14 may analyze the request, intent or activity, and/or determine, for example, based on the analysis, whether to fetch a copy of file 52 from network accessible storage 50, for example by using network interface 12, or to fetch one of the reduced sized versions, e.g. the corresponding file 22. Processor 14 may then fetch a copy of file 52 or the corresponding file 22 according to the determination, and may respond to the request with the fetched file. File 52 may include, for example, audio, video, image, application resource, and/or any other media file known to processor 14.

Processor 14 may analyze the received request, for example, by analyzing characteristics of the software entity. Additionally or alternatively, processor 14 may analyze the received request, the intent or the activity, for example, by analyzing actions performed by the software entity prior to submitting the request or to the interception of the intent/activity. In some embodiments of the present disclosure, for example, based on the analysis, processor 14 may instruct storing a full version 52a of file 52 in local memory 20, for example, in conjunction with one or more of the corresponding reduced-size files 22. Additionally or alternatively, processor 14 may monitor and/or analyze access parameters of various entities to any of the reduced-size files 22 and/or a full-sized version 52a, and/or may instruct, for example based on the monitoring and/or analyzing, keeping the corresponding full version 52a at local memory 20, deleting the corresponding full version 52a from local memory 20 or storing a corresponding full version 52a at local memory 20. The access parameters may include, for example, the last access time, frequency of use, and/or any other suitable access parameters.

In some embodiments of the present disclosure, processor 14 may produce, for instance calculate or select, a score for each file 22 and/or 52a, for example, based on the access parameters. For example, a higher score may indicate a more frequent and/or recent access to a file. Processor 14 may calculate the initial score according to various initial parameters of file 22/52a, which may imply on the file's importance, usability, age and/or activity, such as, for example, the creation date, access pattern, file size, and/or any other relevant parameter. The file's score may change over time and/or may be updated, periodically or as required, by processor 14. For example, as the file becomes less active and/or old, the score given by processor 14 may drop. In case the file becomes more active, for example, the score may increase.

When the score produced for a file 52a and/or 22 drops below a certain predetermined threshold, full version file 52a may be deleted from local memory 20 and/or only the reduced file 22 may be kept at local memory 20. Processor 14 may calculate and/or update the threshold according to, for example, the remaining free space in local memory 20, average size of files 52a and/or 22, the average rate of free space decreasing, and/or any other parameter that may imply, for example, on the urgency of space clearing in memory 20. In some embodiments of the present disclosure, processor 14 may instruct network interface 12, for example, based on the analysis, to send file 52 for storage at network accessible storage 50, and/or to receive the corresponding reduced-size file 22, for example, via network interface 12, for storage at local memory 20. In some other embodiments, processor 14 may reduce media size of file 52 and/or produce a corresponding reduced size file 22, such that, for example, the corresponding reduced-size file 22 may be generated locally by processor 14, and/or stored at local memory 20.

In case processor 14 receives a request for a file 52 or intercepts an intent and/or activity of a software entity that requires and/or calls for a file 52, processor 14 may check when a corresponding full version 52a is stored at local memory 20. In case a corresponding full version 52a is stored at local memory 20, processor 14 may provide the corresponding full version 52a to the relevant software entity. In case a corresponding full version 52a is not stored at local memory 52, processor 14 may check when the operation of the relevant software entity requires a full version of file 52, or a corresponding reduced-size file 22 may suffice. In case processor 14 determines that a corresponding reduced file 22 may suffice the requirements of the operation, processor 14 may provide the corresponding reduced-size file 22 to the relevant software entity. In some embodiments of the present disclosure, intents such as, for example, printing or editing may require the full sized file 52 and/or the full version 52a, wherein intents such as, for example, attachments or viewing may be satisfied with the corresponding reduced-size file 22.

In some cases, processor 14 may decide that one or some of the reduced size files 22 are more adequate, for example for a certain intercepted intent and/or activity, than the full size version 52a. For example, some application may require small-size media. For example, intents such as, for example, file sharing via messaging applications, may be better served by the reduced-size file 22 than by the corresponding full sized version 52a. For such applications and/or intents, processor 14 may provide file 22, even if the respective full size version 52a is stored on the device. In case the reduced file 22 is not present on the device, processor 14 may download it from cloud 50 or generate it on the device, as described in detail herein.

In case the full version of file 52 is required, processor 14 may check when there is access, for example a network connection, to network accessible storage 50. In case there is no access and/or the connection to storage 50 is poor, processor 14 may notify the relevant entity of the failed connection, may provide the corresponding reduced file 22, and/or notify the relevant entity that a reduced file 22 is provided instead of the full version of file 52. In case there is access to storage 50, processor 14 may fetch file 52 and/or provide file 52 to the relevant software entity.

In some embodiments of the present disclosure, processor 14 may carry out the fetching of file 52 from storage 50 by implementing and/or controlling a designated file system 30. Once receiving from processor 14 a request for a file 52, file system 30 may fetch file 52 and/or provide file 52 to the relevant software entity. The fetching may be performed while processor 14, by operation system 16, freezes operation of the software entity until file 52 is fetched and/or provided, for example, when file 52 is required for a read/write operation.

In some other embodiments of the present disclosure, processor 14 may carry out the fetching of file 52 from storage 50 by operating system 16. Operating system 16 may intercept intents and/or activities of a software entity. The intercepted intents and/or activities may require and/or call for a file 52 stored at storage 50. Operating system 16 may fetch the required and/or called for file 52 from storage 50, for example when such intent and/or activity is intercepted. The fetching by operating system 16 may be performed, in some embodiments, transparently to the requiring and/or calling software entity, for example, in the background and/or while enabling continued operation of the requiring and/or calling software entity.

Some embodiments of the present disclosure may vary, for example, in the location of processor 14, in the ability of processor 14 to control operations and/or modules within operating system 16, and/or in the ability of processor 14 to receive file requests, requirements and/or calls. The various embodiments of the present disclosure may vary, for example, in the integration level with operating system 16, in the manner and/or extent they affects the behavior of operating system 16, and/or in the amount of control they have over applications request processing.

For example, some embodiments of the present disclosure are less integrated with operating system 16 and may have reduced control over the file management, wherein the decision which requests are forwarded to processor 14 may be made by operating system 16. Such exemplary embodiment is shown in FIG. 3, which is a schematic illustration of a system 300 for managing file access according to some embodiments of the present disclosure, in which processor 14 is located in an external file managing server. System 300 may include an external file managing server 32, a network accessible storage 50 and a device 10. File managing server 32 may include processor 14. Operating system 16 of device 10 may include a kernel module 17 and file system 18. Processor 14 may run a service on device 10 to monitor file system 18, for example via kernel module 17. Processor 14 may be notified by operating system 16 about file requests made by software entities, and/or may fetch files 52, when required.

When an application or service 60 requires a file 52, kernel module 17 may decide whether to fetch a version from local storage 20 by file system 18, or to notify processor 14, which may fetch the required file 52 from storage 50. In some embodiments of the present disclosure, operating system 16 may notify processor 14 about every request for a relevant kind of file that is made by application or service 60, or about every request for a file of a certain kind. In some embodiments, processor 14 decides whether to fetch the full-sized file 52 from storage 50, and/or to instruct file system 18 to fetch a version from local storage 20, for example, according to the decision considerations described in detail herein above.

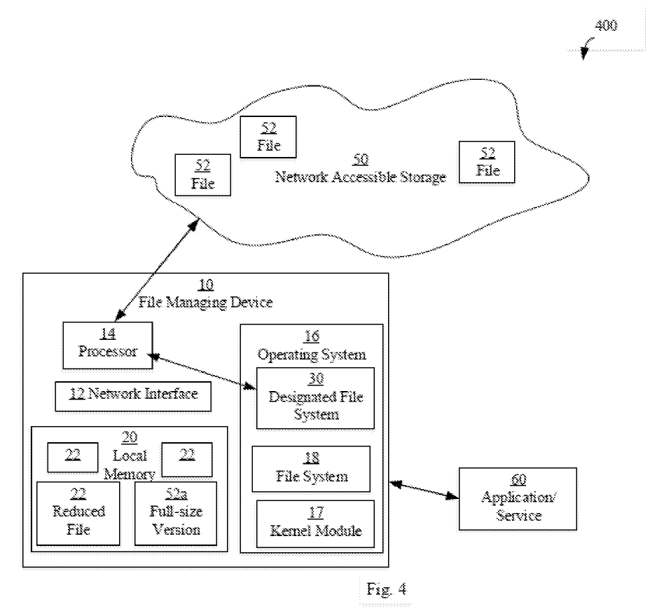

Some other embodiments of the present disclosure are integrated with operating system 16 and have more control of the file management. Such exemplary embodiment is shown in FIG. 4, which is a schematic illustration of a system 400 for managing file access according to some other embodiments of the present disclosure. System 400 may include a network accessible storage 50, a device 10, and a processor 14. Processor 14 may implement and/or control a designated file system 30 in operating system 16 of device 10. Operating system 16 may include a kernel module 17 and file system 18. Designated file system 30 may communicate with and/or control kernel module 17, file system 18, local storage 20, and/or network accessible storage 50.

Designated file system 30 may receive file requests made by an application or service 60, for example via kernel module 17, and/or decide, for example according to the decision considerations described in detail herein above, whether to fetch the full-sized file 52 from storage 50, to instruct file system 18 to fetch one or more of the versions 22 or 52a from local storage 20, and/or to produce or delete a local full version 52a.

Some other embodiments of the present disclosure are both integrated with operating system 16 and have an external application server, and may have complete control of the file management. Such exemplary embodiment is shown in FIG. 5, which is a schematic illustration of a system 500 for managing file access according to further embodiments of the present disclosure. System 500 may include an external file managing server 32, a network accessible storage 50, a device 10, and a processor 14. Processor 14 may be included in file managing server 32, device 10, and/or both. For example, some of the operations of processor 14 may be performed on device 10, and some on server 32. Operating system 16 of device 10 may include a kernel module 17 and file system 18.

Processor 14 may implement and/or control a designated file system 30 in operating system 16 of device 10. Designated file system 30 may communicate with and/or control kernel module 17, file system 18, local storage 20, and/or network accessible storage 50. In some embodiments, designated file system 30 may communicate with and/or control storage 50 via file managing server 32.

Designated file system 30 may receive file requests made by an application or service 60, for example via kernel module 17. Processor 14 may decide, for example according to the decision considerations described in detail herein above, whether to fetch the full-sized file 52 from storage 50, to instruct file system 18 to fetch one or more of the versions 22 or 52a from local storage 20, and/or to produce or delete a local full version 52a.

Additionally, some embodiments of the present disclosure may vary, for example, in the manner reduced-size files 22 are generated and/or stored. For example, in some embodiments, reduced files 22 are generated and stored in the network accessible storage 50, and may be downloaded to device 10 as needed. In some other embodiments, files 22 are generated and stored directly on device 10.

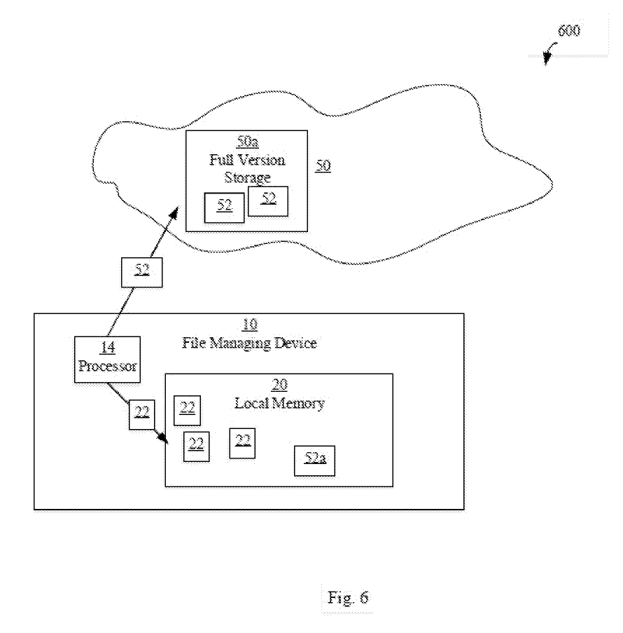

Reference is made to FIG. 6, which is a schematic illustration of a system 600 for generating and storing of reduced-size files 22, according to some embodiments of the present disclosure. System 600 may include a device 10 and a network accessible storage 50. Files 52 may be uploaded to network accessible storage 50 and, for example, stored at a full version storage 50a. Corresponding reduced-size files 22 may be generated on device 10 and stored in local storage 20. A reduced-size file 22 may be generated, for example, upon uploading of a file 52 to storage 50, just when a full version 52a is about to be deleted from local storage 20, or any time in between, for example due to low access frequency or no recent accesses.

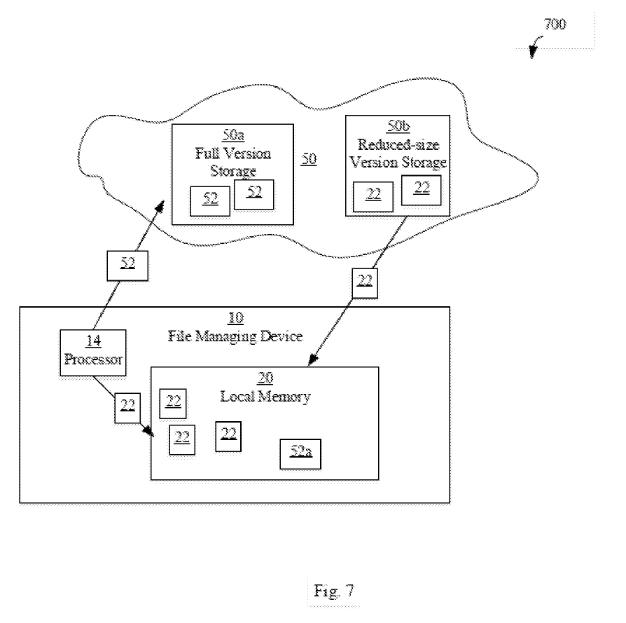

Reference is made to FIG. 7, which is a schematic illustration of a system 700 for generating and storing of reduced-size files 22, according to some other embodiments of the present disclosure. In system 700, network accessible storage 50 may include a full version storage 50a and a reduced-size version storage 50b. Files 52 may be uploaded to network accessible storage 50 and stored, for example, at full version storage 50a. Corresponding reduced-size files 22 may be generated at network accessible storage 50, and stored, for example, at reduced-size version storage 50b. A reduced-size file 22 may be downloaded to device 10 and stored, for example, at local storage 20.

In some embodiments of the present disclosure, reduced-size file 22 is downloaded to device 10 once it is generated at network accessible storage 50. Then, reduced file 22 may be used when required and/or in case there is no corresponding full version 52a on device 10.

In some other embodiments, reduced-size file 22 is downloaded to device 10 when a corresponding full version 52a is about to be deleted from device 10, for example due to low access frequency or no recent accesses. For example, processor 14 may download a reduced-size file 22 when a produced access score of a file 52a approaches a predetermined threshold.

In some embodiments of the present disclosure, processor 14 may choose between downloading a cloud-generated reduced-size file 22 and generating a reduced size file 22 locally. The choice may be influenced by network and/or cloud accessibility, and the need for the reduced-size file 22. For instance, after full size file 52 is uploaded, reduced-size file 22 may not yet be downloaded and/or produced. Once the access score of full-size version 52a drops below the threshold, file 52a may be deleted from local memory 20 and corresponding reduced file(s) 22 may be produced locally and/or downloaded by processor 14.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

What is claimed is:

1. A device of managing an access to a file, comprising
a network interface;
a local memory adapted to store at least one reduced-size version of a media file stored in a network accessible storage;
at least one processor adapted to:
receive a request to access the media file via a file system of an operating system executed by the at least one processor;
analyze the request and perform one of:
fetch, using the network interface, a copy of the media file from the network accessible storage and respond to the request with the copy; and
respond to the request with one of the reduced-size versions according to the analysis.

2. The device of claim 1, wherein the analysis comprises an analysis of at least one of a characteristic of an application, an operating system service and a device framework service submitting the request.

3. The device of claim 1, wherein the request is received via a kernel level IO operation.

4. The device of claim 1, wherein the analysis comprises an analysis of at least one action performed by an application submitting the request prior to submitting the request.

5. The device claim 1, wherein the at least one processor is adapted to instruct storing a full version of said media file in conjunction with the at least one reduced-size versions.

6. The device of claim 5, wherein the at least one processor is adapted to monitor at least one access characteristic of an access to the reduced-size version and to instruct deleting the full version from the local memory according to the at least one access characteristic.

7. The device of claim 1, wherein the media file encodes a member of a group consisting of an image, a video, a set of images, and an audio file, and a graphic data file.

8. The device of claim 1, wherein the local memory is a non-volatile memory.

9. The device of claim 1, wherein a storage size of at least one of the reduced-size versions is of a fixed relation to the storage size of the original media file.

10. The device of claim 1, wherein a storage size of at least one of the reduced-size versions is of a pre-determined fixed size.

11. The device of claim 1, wherein the at least one processor is adapted to instruct the network interface to send the media file for storage at the network accessible storage; wherein at least one of the reduced-size versions are received via the network interface for storage at the local memory.

12. The device of claim 1, wherein the at least one processor is adapted to instruct the network interface to send the media file for storage at the network accessible storage; wherein at least one of the reduced-size versions are generated locally on the device by at least one processor adapted to reduce media size for storage at the local memory.

13. A method of managing an access to a file, comprising
storing in a local memory of a device at least one reduced-size versions of a media file stored in a network accessible storage;
receiving a request to access the media file via a file system of an operating system executed by at least one processor of the device; and
analyzing the request and performing one of:
fetching, using the network interface, a copy of the media file from the network accessible storage and responding to the request with the copy; and
responding to the request with at least one of the reduced-size versions.

14. A non-transitory computer readable storage medium storing computer executable instructions for managing access to a file, the instructions comprising:
storing in a local memory of a device at least one reduced-size versions of a media file stored in a network accessible storage;
receiving a request to access the media file via a file system of an operating system executed by at least one processor of the device; and
analyzing the request and performing one of:
fetching, using the network interface, a copy of the media file from the network accessible storage and responding to the request with the copy; and
responding to the request with at least one of the reduced-size versions.
